(19) United States
(12) Patent Application Publication
(10) Pub. No.: US 2008/0254900 A1
(43) Pub. Date: Oct. 16, 2008

(54) Axial lash control for a vane-type cam phaser

(76) Inventor: Jason M. Urckfitz, Mendon, NY (US)

Correspondence Address: DELPHI TECHNOLOGIES, INC., M/C 480-410-202, PO BOX 5052, TROY, MI, 48007, US

(21) Appl. No.: 12/152,346

(22) Filed: May 14, 2008

Related U.S. Application Data
(63) Continuation-in-part of application No. 11/638,595, filed on Dec. 13, 2006.

(51) Int. Cl. F16D 3/10

(52) U.S. Cl. 464/2

(57) ABSTRACT

A camshaft phaser for varying the timing of valves in an internal combustion engine. A rotor includes a plurality of vanes disposed in a stator having a plurality of lobes, forming a plurality of alternating timing advance and timing retard chambers. Pressurized oil is supplied selectively to the chambers to change the phase angle of the camshaft with respect to the crankshaft. The rotor is captured between a stator plate and a rotor cover plate. Axial surfaces of the rotor form wiping surfaces with their respective plates. The rotor is divided equatorially into two interlocking sections, the lower section riding on the stator plate and the upper section riding on the cover plate. An axially slidable labyrintian seal formed at the juncture of the upper and lower sections prevents oil leakage. A lash spring between the upper and lower sections urges the sections into zero-lash with their respective plates.

### RELATIONSHIP TO OTHER APPLICATIONS AND PATENTS

The present application is a Continuation-In-Part of a pending U.S. patent application, Ser. No. 11/638,595, filed Dec. 13, 2006.

### TECHNICAL FIELD

The present invention relates to vane-type camshaft phasers for varying the phase relationship between crankshafts and camshafts in internal combustion engines; and more particularly, to a phaser wherein the rotor is formed in two slidably interlocking sections with a compression spring disposed therebetween such that the two sections are urged in opposite directions against the stator plate and the rotor cover plate, respectively, to control oil leakage past both plates; the two rotor sections are sealed against leakage therebetween by an axially slidable labyrinthian seal.

### BACKGROUND OF THE INVENTION

Camshaft phasers for varying the phase relationship between the crankshaft and a camshaft of an internal combustion engine are well known. A prior art vane-type phaser generally comprises a plurality of outwardly-extending vanes on a rotor interspersed with a plurality of inwardly-extending lobes on a stator, forming alternating advance and retard chambers between the vanes and lobes. Engine oil is supplied via a multiport oil control valve (OCV), in accordance with an engine control module, to either the advance or retard chambers as required to meet current or anticipated engine operating conditions.

A problem to be overcome in phaser construction is leakage of pressurized oil across the vanes between the rotor-advance and rotor-retard chambers. Typically the radial ends of the rotor vanes and stator lobes are provided with flexible wipers that effectively stop leakage in those regions. However, in prior art vane-type phasers, the axial faces of the rotor that slide past the axial faces of the stator plate (i.e., a first cover plate) and the rotor cover plate (i.e., a second cover plate), respectively, are not provided with dynamic sealing means but rather rely for sealing on accurate machining of the axial height of the rotor with respect to the distance (stator height) between the mating plates. Controlling manufacturing tolerances (axial lash) of the height of the rotor chamber and the height of the rotor is very costly and subject to error, as well as to variation during the working lifetime of the phaser. In the prior art of one-piece rotors, a zero-lash rotor within a stator is a practical impossibility because of build tolerances.

In the parent application and invention, the rotor is split along an equatorial plane, defining first and second rotor sections. At least one, and preferably both, of the rotor sections is axially slidable within the stator, defining a section gap between the rotor sections, but is constrained from rotational motion independent of the other rotor section. Resilient sealing means comprising a specially-formed elastomeric seal is disposed between the first and second rotor sections. In a relaxed-seal state, the axial height of the rotor assembly is greater than the axial height of the rotor chamber in the stator such that the seal is compressed upon assembly of the phaser. The compressed seal not only prevents leakage across the section gap but also urges the axial faces of the rotor vanes against their mating chamber surfaces to prevent leakage past the vanes.

Although the parent invention provides excellent pressure isolation of the advance and retard chambers, a drawback is that a separate compressed seal must be manufactured and installed with each rotor vane.

What is needed in the art of vane-type camshaft phasers is an active mechanical means to seal the axial faces of the rotor against leakage between adjacent phaser chambers without resort to a resilient seal between first and second sections of a phaser.

It is a principal object of the present invention to improve the effectiveness and reliability of a vane-type camshaft phaser.

### SUMMARY OF THE INVENTION

Briefly described, a vane-type camshaft phaser in accordance with the invention for varying the timing of combustion valves in an internal combustion engine includes a rotor having a plurality of vanes disposed in a stator having a plurality of lobes, the interspersion of vanes and lobes defining a plurality of alternating valve timing advance and valve timing retard chambers with respect to the engine crankshaft. Pressurized oil is supplied selectively to either the valve timing advance chambers or the valve timing retard chambers to change the phase angle of the camshaft with respect to the engine crankshaft. The vanes and lobes are provided with wipers to prevent circumferential oil leakage between chambers around the respective radial vane and lobe ends. The rotor is captured axially between a stator plate and a rotor cover plate, the axial surfaces of the rotor forming wiping surfaces with their respective stator and cover plates.

The rotor is divided equatorially into two interlocking sections, the lower section riding on the stator plate and the upper section riding on the cover plate. An axially slidable labyrinthian seal is formed at the juncture of the upper and lower rotor sections to prevent oil leakage therebetween. A lash spring is disposed between the upper and lower sections to urge the respective rotor sections into zero-lash relationship with their respective plates.

### BRIEF DESCRIPTION OF THE DRAWINGS

The present invention will now be described, by way of example, with reference to the accompanying drawings, in which:

FIG. 1 is a plan view of an interior mating surface of a second rotor section in accordance with the invention;

FIG. 2 is a plan view of an interior mating surface of a first rotor section in accordance with the invention;

FIG. 3 is a schematic cross-sectional view of a portion of a camshaft phaser comprising a rotor in accordance with the invention; and

FIGS. 4 and 5 are cross-sectional views of two alternative embodiments of the invention, taken along Line 4,5 in FIG. 3.

### DESCRIPTION OF THE PREFERRED EMBODIMENTS

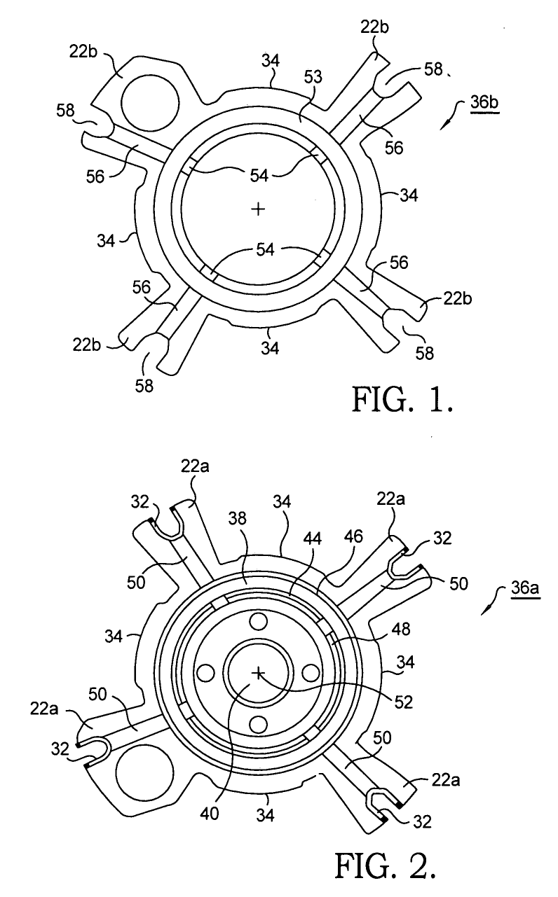

Referring to FIGS. 1 through 3, an improved vane-type camshaft phaser 10 in accordance with the present invention comprises a pulley or sprocket and stator 12 for engaging a timing chain or belt (not shown) operated by an engine crankshaft (not shown). Stator 12 is provided with radial walls 14 and a stator plate surface 16 for receiving a rotor 18 having a hub 20 and vanes 22. Hub 20 is coaxial with a central bore 24 in stator 12, allowing access of an end of an engine camshaft (not shown) into rotor hub 20 during mounting of phaser 10 onto an internal combustion engine 26 during assembly thereof. Stator 12 is closed by a rotor cover plate 28 having a surface 30 opposite stator plate surface 16, forming advance and retard chambers between the rotor and the stator and defining a first height 32. Seals 33 are mounted at the ends of vanes 22 for sweeping radial walls 14 to prevent oil leakage past vanes 22 during operation of phaser 10. Similar seals (not shown) may be mounted in the ends of inwardly-extending stator lobes (not shown) to sweep the valleys 34 of the rotor between vanes 22.

The rotor 18 of phaser 10 is split on a plane perpendicular (“equatorially”) to axis 52 of rotor 18, defining first and second rotor portions 36a,36b, at least one of which, and preferably both, is axially slidable within stator 12 but is constrained from rotational motion independent of the other rotor portion by being interlocked therewith, as described below.

In a first embodiment 10a shown in FIGS. 1 through 4, first portion 36a is provided with a square-sided annular groove 38 surrounding central opening 40 for receiving a compression lash spring 42. Groove 38 has inner and outer raised ribs 44,46. A circular channel 48 is radially inboard of rib 44. Each vane 22a has a square-sided groove 50 extending from seal 33 to outer raised rib 46. By “square-sided” is meant having sides lying in planes substantially parallel to rotor axis 52.

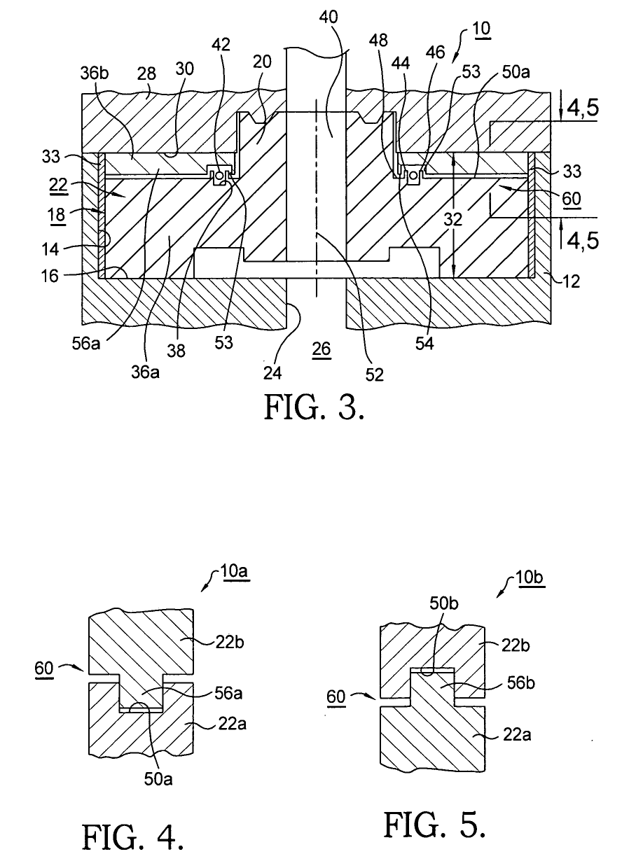

Second portion 36b has a square-sided circular groove 53 wide enough to straddle inner and outer ribs 44,46, as shown in FIG. 3, and a plurality of tangs 54 for extending into circular channel 48. Each vane 22b has a square-sided rib 56 extending from seal pocket 58 to groove 53.

Referring to FIGS. 1-3 and 5, a second embodiment 10b is identical in all respects to first embodiment 10a except that the recited ribs (56) and grooves (50) are reversed between first portion 36a and second portion 36b.

In either embodiment 10a or 10b, it will be seen that an axially slidable labyrinthian seal 60 is formed between rib 56a,b and groove 50b,a, respectively. A labyrinthian seal is also formed between inner and outer ribs 44,46 and circular groove 38. A plurality of grooves 50b,a and mating ribs 56a,b on each vane 22a,b to lengthen the fluid flow path through seal 60 is not shown but is fully contemplated by the invention.

In operation, at least one and preferably both of interlocked first and second rotor portions 36a,36b are free to move axially within stator 12 to fully engage first portion 36a with stator plate surface 16 and second portion 36b with rotor cover plate surface 30, forming dynamic liquid seals therebetween. Compression lash spring 42 engages grooves 38 and 53 to urge first and second rotor portions 36a,36b away from each other, eliminating the axial lash within stator 12 and cover plate 28. Leakage between first and second-rotor portions 36a,36b is prevented by axially slidable labyrinthian seal 60. By varying the spring rate of lash spring 42, specific points on the plate surfaces that are more prone to leakage may be targeted and, by increasing the spring rate, rotor stability may be improved.

Before assembly of phaser 10a or 10b, the axial height of the rotor assembly (two rotor portions 36a,36b plus the net height of spring 42) is greater than the axial height 32 of the rotor chamber in stator 12 between surfaces 16,30. The rotor assembly is compressed by installation of cover plate 28 upon assembly of the phaser, thereby compressing lash spring 42.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A camshaft phaser comprising:
a) a stator having radial walls and bounded by a first cover plate on a first side and by a second cover plate on a second side to define a chamber therewithin having a first height between said first and second cover plates;
b) a rotor disposed within said chamber and having a hub and having a plurality of angularly spaced-apart vanes extending outwards from said hub toward stator walls of said chamber, wherein said rotor is equatorially divided into a first rotor portion and a second rotor portion, said first and second portions being configured along their mutual faces to define an axially slidable labyrinthian seal therebetween; and
c) a spring disposed between said first and second rotor portions to urge said first and second rotor portions axially apart and into sealing contact with said first and second cover plates, respectively.

2. A camshaft phaser in accordance with claim 1 wherein said axially slidable labyrinthian seal comprises at least one of a groove and a rib on said first rotor portion for receiving at least one of a rib and a groove on said second rotor portion.

3. A camshaft phaser in accordance with claim 2 wherein said ribs and grooves are formed along mating axial surfaces of said first and second rotor portions along said angularly spaced-apart vanes and around said spring in said hub.

4. A camshaft phaser in accordance with claim 2 wherein said ribs and grooves are mutually close-fitting and axially slidable to permit said first and second rotor portions to move into sealing contact with said first and second cover plates, respectively.

5. A camshaft phaser in accordance with claim 4 wherein said ribs and grooves have sides lying in planes parallel to the axis of said phaser.

6. A camshaft phaser in accordance with claim 1 wherein the combined heights of said first and second rotor portions and said spring when relaxed define a second height greater than said first height such that said rotor is compressed axially to said first height to compress said spring during assembly of said phaser.

7. A camshaft phaser in accordance with claim 1 wherein one of said first and second rotor portions is axially fixed and the other of said rotor portions is slidably disposed for axial motion within said chamber.

8. A camshaft phaser in accordance with claim 1 wherein both of said first and second rotor portions are slidably disposed for axial motion within said chamber.

9. An internal combustion engine comprising a camshaft phaser including
a stator having radial walls and bounded by a first cover plate on a first side and by a second cover plate on a second side to define a chamber therewithin having a first height between said first and second cover plates,
a rotor disposed within said chamber and having a hub and having a plurality of angularly spaced-apart vanes extending outwards from said hub toward stator walls of said chamber, wherein said rotor is equatorially divided into a first rotor portion and a second rotor portion, said first and second portions being configured along their mutual faces to define an axially slidable labyrinthian seal therebetween, and
a spring disposed between said first and second rotor portions to urge said first and second rotor portions axially apart and into sealing contact with said first and second cover plates, respectively.
